(19) United States
(12) Patent Application Publication
(10) Pub. No.: US 2006/0108974 A1
(43) Pub. Date: May 25, 2006

(54) Generic rechargeable battery and charging system

(76) Inventor: Homero Castillo, Humble, TX (US)

Correspondence Address: PAUL S MADAN;MADAN, MOSSMAN & SRIRAM, PC, 2603 AUGUSTA, SUITE 700, HOUSTON, TX, 77057-1130, US

(21) Appl. No.: 10/998,308

(22) Filed: Nov. 24, 2004

(51) Int. Cl. H02J 7/00

(52) U.S. Cl. 320/107

(57) ABSTRACT

A rechargeable battery includes a rechargeable element, a transfer device and control circuitry. The transfer device may be a secondary coil with a corresponding primary coil that is supplied electrical power. The transfer device may be a photovoltaic cell supplied with light energy or a thermoelectric generator supplied with heat.

### BACKGROUND OF THE INVENTION

1. Field of the Invention

The present invention is a rechargeable battery and a system for use in recharging the battery.

2. Background of the Art

The prior art teaches various systems for charging a battery pack for use in a portable device. One such prior art system for computer devices includes a wall adapter unit connected by a cord to a battery charger. The battery charger contains one or more vertical slots in a top surface thereof in which battery packs are inserted for charging. Charging is achieved through direct electrical contact to external electrodes. A disadvantage of this design is that as new batteries are developed for new or different portable computing devices, new battery chargers having slots that conform to the shape and electrode arrangement of the new batteries must be developed.

U.S. Pat. No. 5,734,254 to Stephens discloses a battery pack that comprises a battery mounted within a housing and coupled through a power converter to a secondary transformer winding. A communication port formed in an exterior of said housing permits propagation of battery status signals outside of the housing. The communication port may be implemented using infrared technology and a proximity indicating device may be provided to indicate the presence of the battery pack to a charger. Feedback control logic controls an output of the power converter based on sensed battery status signals.

U.S. Pat. No. 6,310,960 to Saaski et al. discloses a contactless rechargeable hearing aid system in which a rechargeable hearing aid may be optically or inductively recharged by an optical or an inductive recharger. The optically rechargeable hearing aid may have a dual purpose optical fiber that may act as a light conduit for the recharging light, and that may also act as a draw string for the hearing aid. The rechargeable hearing aid may use a high energy nickel metal-hydride rechargeable battery or a high energy, high voltage lithium based rechargeable battery, in conjunction with a DC to DC voltage regulating circuit for converting the rechargeable battery's declining DC output voltage to the fixed DC input voltage needed by the hearing aid's audio related circuitry. The DC to DC voltage regulating circuit may also help to present a supply impedance that matches the input impedance of the audio related circuitry in the hearing aid. The rechargeable battery may have an alternately folded cell stack, a spiral wound cell stack or an accordion folded cell stack, in order to provide, in a minimized volume, the large anode, cathode and electrolyte areas that may be needed to reduce the rechargeable battery's output impedance, in order to help reduce internal resistance losses during use of the battery.

Numerous other devices show the use of inductive coupling for charging batteries that are used in conjunction with electric toothbrushes, power drills, power meter readout devices, etc. Common to all of these devices and the ones specifically identified above is the use of batteries that are specifically tailored for a particular appliance, i.e., a completely new system is required for each particular application.

The need for a contactless battery charger that is not appliance-dependent is addressed partially in U.S. Pat. No. 6,040,680 to Toya et al. Disclosed therein is a battery pack and charging stand that has a primary coil and a secondary coil. The secondary coil is contained inside of the battery pack and the primary coil is contained inside of the charging stand such that electrical power is transmitted from a primary coil to a secondary coil by electromagnetic induction. The battery pack is attached to the charging stand directly or via a portable electrical device which is powered by the battery pack, and a rechargeable battery contained inside of the battery pack is charged. The battery pack comprises the secondary coil, which is electromagnetically coupled with the primary coil, and a control circuit which controls electrical power induced in the secondary coil and charges the rechargeable batteries.

The secondary coil of Toya is positioned close to the bottom surface of a battery pack case with the center axis of the coil oriented in the elongated direction of the elongated case. The charging stand houses the primary coil at a position which is closest to the secondary coil. The primary coil of the charging stand transfers power by electromagnetic induction to the secondary coil, then the control circuit controls electrical power induced in the secondary coil and charges the rechargeable batteries of the battery pack.

A drawback of the Toya device is that the secondary coil and the control circuitry for the battery pack are still external to the battery, and in a preferred embodiment, the battery pack is still appliance specific.

There is a need for a battery that can be charged without electrical contacts. Such a battery should have “broad” applicability in that it can effectively replace conventional batteries in standard sizes (e.g., AAA-D, and other sizes for devices like cameras). The present invention satisfies this need.

### SUMMARY OF THE INVENTION

The present invention is an electrical energy storage device that includes a rechargeable element which stores electrical energy. A coil is inductively coupled to a source of electrical power. Control circuitry is integrated with the rechargeable element and the coil which controls a flow of electricity to the rechargeable element. The rechargeable device may be a standard size rechargeable battery. The energy storage device may have a size substantially the same as a standard size rechargeable battery. The coil is inductively coupled to the source of electrical power through a primary coil. The control circuitry comprises a rectifier and a current limiter.

Another embodiment of the present invention is a system for storage of electrical energy in a rechargeable element. A chamber has a primary coil coupled to a source of electrical power. The system includes a rechargeable battery that has a secondary coil and control circuitry integrated with the rechargeable element. With the rechargeable battery positioned inside the chamber, the secondary coil is inductively coupled to the primary coil. The rechargeable battery may be inside an appliance such as a camera, personal digital assistant, radio, shaver, toothbrush, beeper, cell phone, or a chemical sensor such as a H₂S sensor. The source of electrical power may be an alternating current source. The source of electrical power may be a direct current source, in which case the system comprises a DC/AC converter.

In another embodiment, the invention is a method of storing electrical energy. A battery integrally comprised of (A) a secondary coil, (B) a rechargeable element, and, (C) control circuitry, are positioned in proximity to a primary coil. The primary coil is coupled to a source of electrical power, and electrical energy is stored in the rechargeable element. The battery may be positioned inside a chamber that includes the primary coil. The source of electrical power may be an alternating current source. In another embodiment, the source of electrical power may be a direct current source, in which case, the method further comprises a DC/AC converter.

### BRIEF DESCRIPTION OF THE DRAWINGS

The present invention is best understood with reference to the accompanying drawings in which like numerals refer to like elements, and in which:

FIG. 1 (prior art) is a vertical cross-sectional view of the battery pack and charging stand;

FIGS. 2a-2c show the basic concepts of a rechargeable battery according to the present invention;

FIG. 3 is a schematic circuit diagram for the embodiment of FIG. 2c;

FIGS. 4a and 4b illustrate a system for recharging batteries;

FIG. 5 illustrates a system for recharging batteries inside appliances; and

FIGS. 6a and 6b illustrate an alternate embodiment of the invention.

### DETAILED DESCRIPTION OF THE INVENTION

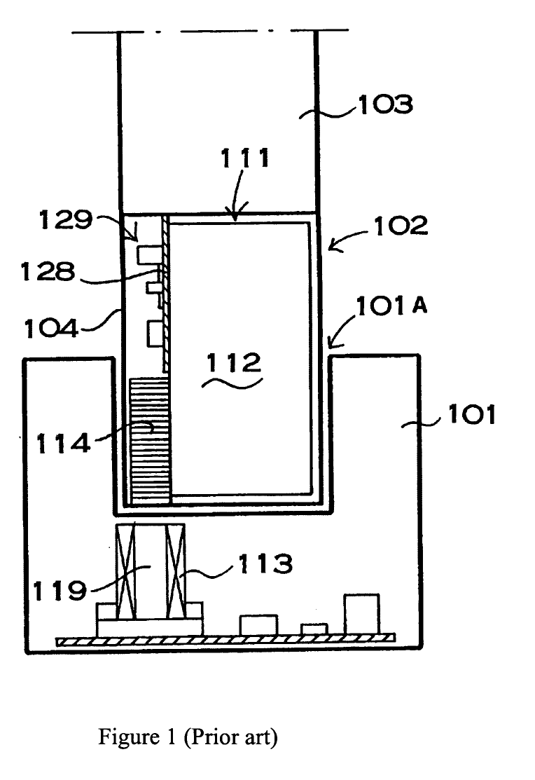

FIG. 1 (prior art) is a cross-sectional view in which a portable electrical device 103 is attached to the charging stand 101. The battery pack 102 shown in FIG. 1 comprises a cylindrically wound secondary coil 114. The secondary coil 114 is disposed at the bottom of the case 104 with its center axis oriented in the long direction of the case 104 and the battery, which is the vertical direction in FIG. 1. The case 104 is rectangular shaped thin plastic and contains the rectangular rechargeable battery 111 inside thereof. The rectangular battery is thin and flat. The width of the rectangular case 104 is wider than the rectangular battery so that a gap is defined between the side of the rectangular case 104 and rectangular battery. The secondary coil 114 is disposed in the gap between the case 104 and the rechargeable battery 111. The secondary coil 114 is provided on the bottom surface of the case 104, and a printed circuit board (PCB) 128 is provided above the secondary coil 114.

The printed circuit board 128 is thin and elongated with substantially the same width as the thickness of the rectangular battery. The printed circuit board 128 is provided at the side of the rectangular battery and is insulated from the batteries. The printed circuit board 128 comprises electronic parts or components 129 which constitute the control circuit and the protection circuit thereon.

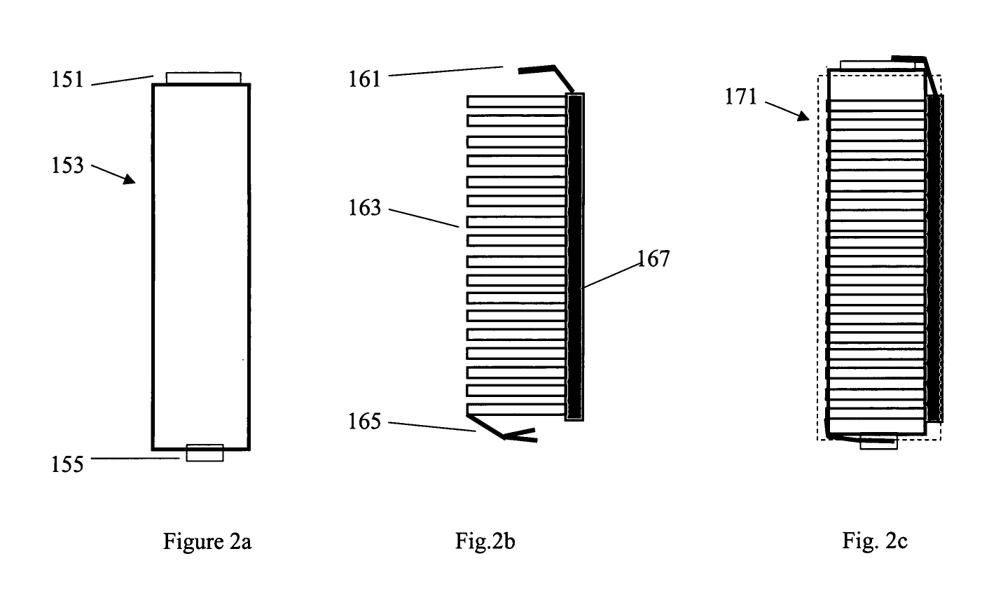

The concept underlying the present invention may be understood with reference to FIGS. 2a-2c. A suitable starting point is a rechargeable element 153 that is provided with terminals 151 and 155. The rechargeable element may be a conventional rechargeable battery such as an alkaline battery, a Ni—Cd battery, or a Ni-MH battery. A charging element that is part of the battery according to the present invention is shown in FIG. 2b and comprises a coil 163, leads 161 and 165 that can make contact with the corresponding terminals 151 and 153 on the rechargeable element. The charging element also includes control circuitry 167, the operation of which is described below. Combining the structures of FIGS. 2a and 2b gives the structure shown in FIG. 2c. The dashed line 171 gives the outline of the rechargeable battery according to the present invention. It should be noted that the control circuitry 167 is depicted as being on one side of the coil 163, but it could also be distributed around the circumference of the coil. In one embodiment of the invention, the control circuitry is implemented on a PCB having a suitable cylindrical shape.

Comparing FIGS. 2a and 2c, it can be seen that the length of the battery 171 is substantially the same as the length of the rechargeable element 151. If the rechargeable element 151 is of cylindrical shape, then the diameter of the battery 171 may be slightly greater than the diameter of the rechargeable element 151. Thus, in one embodiment of the present invention, the battery 171 could appear also have a standard cylindrical shape. Reference is made to Table 1 which gives the standard dimensions of various types of batteries.

TABLE 1
SOME STANDARD BATTERY SIZES

| | Diameter | Length | NiMH | Nicad |
|---|---|---|---|---|
| Battery Type | mm | mm | weight g | weight g |
| 1/3 A | 17 | 21 | 15 | 10 |
| 2/3 A | 17 | 28.5 | 20-23 | 18-20 |
| 4/5 A | 17 | 43 | 32-35 | 26-31 |
| A | 17 | 50 | 40 | 32 |
| 1/3 AA | 14.2 | 17.5 | 7 | 6.5 |
| 2/3 AA | 14.2 | 28.7 | 13-16 | 13-15 |
| 4/3 AA | 14.2 | 65.2 | 30 | 30 |
| 4/5 AA | 14.2 | 43 | 22 | 20 |
| AA | 14.2 | 50 | 27 | 21 |
| 1/3 AAA | 10.5 | 20.5 | 5.5 | 5.5 |
| 1/4 AAA | 10.5 | 14 | 2.5-4 | 2.5-3.5 |
| 2/3 AAA | 10.5 | 30 | 8-9 | 6-8 |
| 4/3 AAA | 10.5 | 67 | 18 | 17 |
| 5/3 AAA | 10.5 | 67 | 19 | 19 |
| 5/4 AAA | 10.5 | 50 | 15 | 14 |
| 2/3 C | 26 | 31 | 50 | 45 |
| C | 26 | 46 | 80 | 72 |
| SC = Sub C | | | | |
| 2/3 SC | 23 | 28 | 28 | 25 |
| 4/3 SC | 23 | 50 | 66 | 60 |
| 4/5 SC | 23 | 34 | 42 | 38 |
| SC | 23 | 43 | 55 | 52 |
| 1/2 D | 33 | 37 | 81 | 81-84 |
| 4/3 D | 33 | 89 | 175 | 140-190 |
| D | 33 | 58 | 105-160 | 105-145 |

It is easy to see that starting with a rechargeable element of size ¼AAA, an inductively rechargeable battery of size ⅓AA can be obtained. Similarly, an A size battery according to the present invention can be made using a rechargeable element of size AA, and so forth. A battery according to the present invention is an integrated assembly that includes a rechargeable element, a coil, and control circuitry. The battery is a storage device of electrical energy.

In another embodiment of the invention, the control circuitry 167 may be positioned at an end of the rechargeable element 153. With such a configuration, since there is no significant contribution to the diameter from the coil 163, an AAA rechargeable element simply becomes part of a longer AAA battery, an AA rechargeable element becomes part of a longer AA battery and so on.

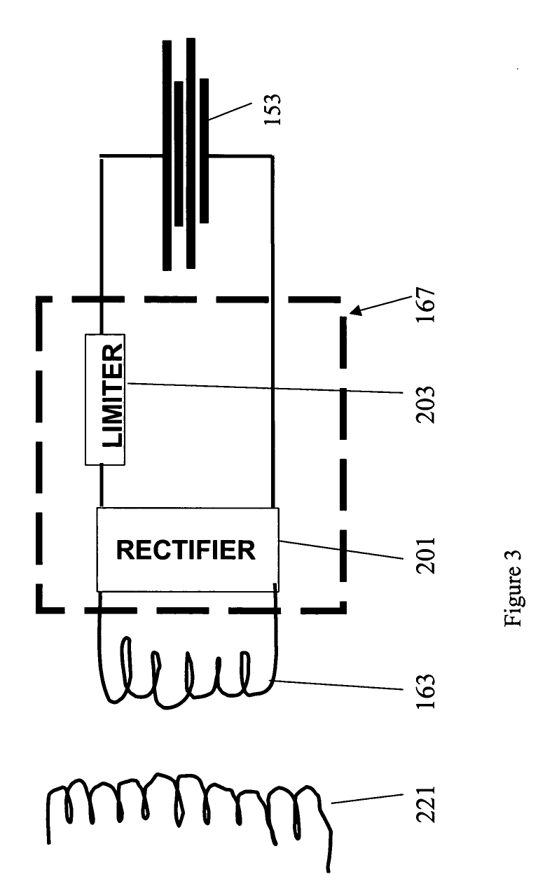

Turning now to FIG. 3, an equivalent circuit diagram for the embodiment of FIG. 2c is shown. In its simplest form, the control circuitry 167 comprises a rectifier 201 and a current limiter 203. The rechargeable element 153 and the secondary coil 163 are shown in the circuit. The primary coil is shown by 221. Not shown is the power source for the primary coil. This is discussed later in this document.

When an alternating current is passed through the primary coil 221, a voltage is induced in the secondary coil 163. The control circuitry 167 uses this induced secondary current to charge the rechargeable element 153. As noted above, the bare minimum requirements for the control circuitry are shown in FIG. 3 and prior art is replete with different control circuits for battery charging.

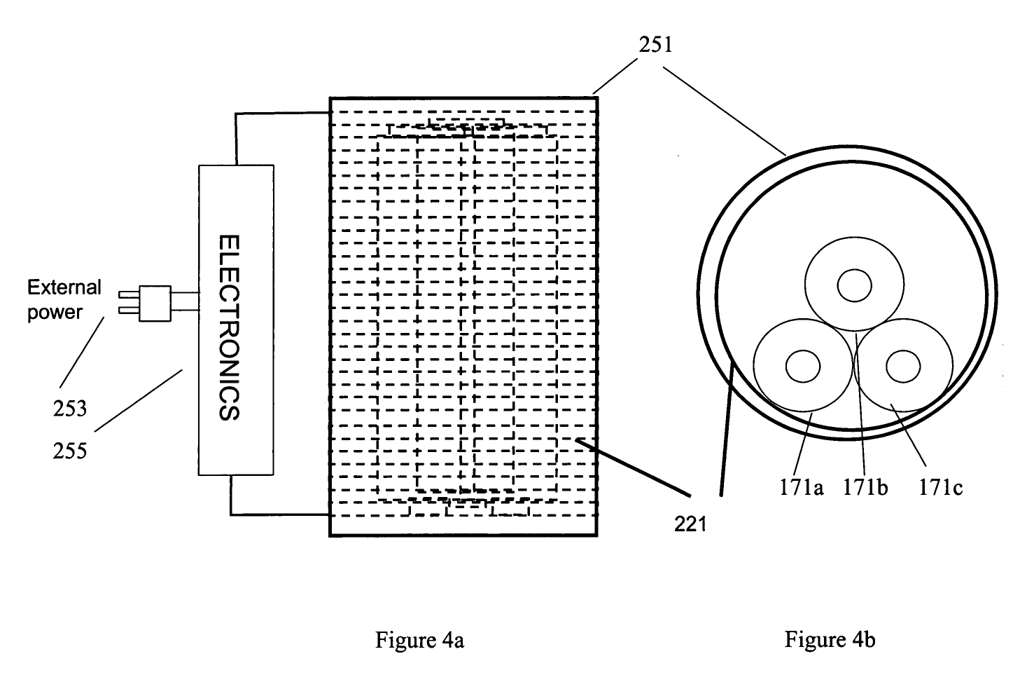

Referring now to FIGS. 4a and 4b, shown therein are two views of three batteries 171a, 171b, 171c corresponding to 171 in FIG. 2c. The secondary windings and control circuitry for the batteries 171a, 171b, 171c are not shown: the batteries are shown within a chamber 251 with the primary coil winding indicated by 221. The primary winding is connected to an external power source 253 through suitable electronic circuitry 255.

With the system as shown in FIGS. 4a and 4b, when the external power source is connected to the primary winding 221, a voltage is induced in the secondary windings (not shown in FIG. 4b) which in turn charges the rechargeable elements of batteries 171a, 171b, 171c. It should be noted that in FIGS. 4a, 4b, the primary winding 221 is shown on the inside of the chamber 251. This is for illustrative purposes only, and the primary winding could be on the outside of the chamber 251.

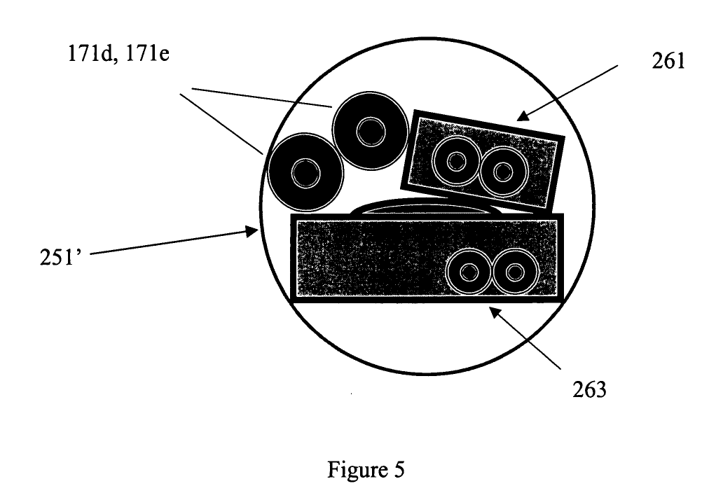

FIG. 5 shows another embodiment of the invention in which the chamber 251′ is large enough to contain within it various electronic devices, each of which has one or more batteries of the type discussed above with respect to FIGS. 2a-2c. For simplifying the illustration, the primary coil is not shown. Within the chamber 251 are two batteries 171d, 171e; a camera 263 having one or more batteries according to the present invention; and a cell phone 261 having one or more batteries according to the present invention. As long as appliances (e.g., the cell phone or the camera) do not have conducting bodies that enclose the batteries, the system of FIG. 5 enables charging of batteries inside the appliances. Other examples of appliances that may be placed inside the chamber 251′ are a personal digital assistant, radio, shaver, toothbrush, beeper, or a chemical sensor such as a H₂S sensor.

In one embodiment of the invention, the external power source 253 comprises a battery, such as the battery of an automobile, boat or DC supply on an aeroplane, and the electronic circuitry 255 comprises a DC/AC converter. With such a configuration, the system of FIG. 5 can be used to charge batteries (either by themselves or within an appliance) from a DC power source. The convenience of such an arrangement should be clear as portable batteries are then charged using a commonly available mobile source.

The embodiments of the invention shown above involve inductive coupling of the primary coil with the secondary coil. This is equivalent to a transformer. The examples shown have corresponded to transformers with air cores: this is not a limitation of the present invention. In one embodiment of the invention, a core may be provided along with the secondary winding. In another embodiment of the invention, a core may be proved with the primary winding. Use of such cores increases the efficiency of the magnetic coupling between the primary and the secondary coils.

In the embodiments of the invention discussed above, three important components are involved. One is an external source of energy, the second is a portable energy storage device, the third is a coupling device that transfers energy from the external source to the energy storage device. Specifically, in the examples discussed, the energy storage device stores electrical energy, the external energy source is a source of electrical energy and the coupling device is an inductive coupling device. Other embodiments of the invention are discussed next.

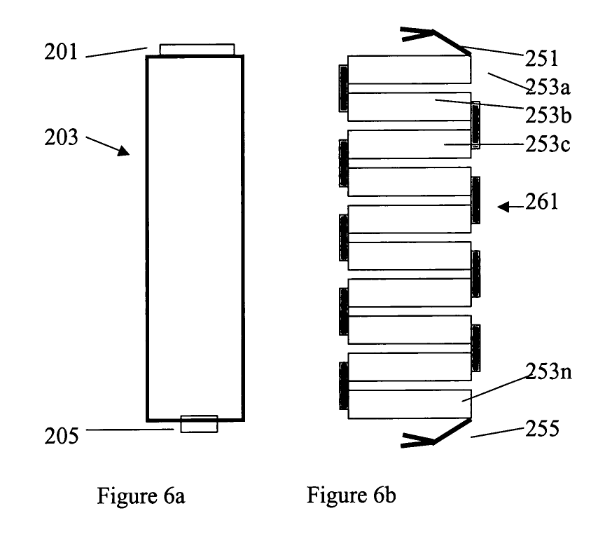

One alternate embodiment of the invention is shown in FIGS. 6a and 6b. FIG. 6a shows one of the components, a rechargeable element 201 that may be similar to the rechargeable element 153 shown in FIG. 2a. Another component of the energy storage device is a coupling device 261 that has leads 251 and 253 that provide current to the rechargeable element. In one embodiment of the invention, the coupling device may be a series of photovoltaic cells 253a, 253b, 253c . . . 253n that, when exposed to an external light source (not shown), produce electrical power that may be used to charge the rechargeable element. Depending upon the specifics of the photovoltaic cells, the energy storage device may function, for example, when exposed to sunlight or to ambient light indoors. To simplify the illustration, the assembled energy storage device is not shown.

Another embodiment of the invention uses a variant of FIG. 6b in which the coupling device may be thermoelectric power generator that produces electrical power when exposed to heat. With such a device, the energy storage device can be charged even in darkness provided a heat source is available.

While the foregoing disclosure is directed to the preferred embodiments of the invention, various modifications will be apparent to those skilled in the art. It is intended that all variations within the scope of the appended claims be embraced by the foregoing disclosure.

What is claimed is:

1. An electrical energy storage device comprising:
(a) a rechargeable element which stores electrical energy;
(b) a coupling device that receives power from an external source of power and outputs electrical power; and
(c) control circuitry integrated with the rechargeable element and the coupling device which controls a flow of electricity to the rechargeable element.

2. The device of claim 1 wherein the external power source comprises a source of electrical power and the coupling device comprises a coil.

3. The device of claim 1 wherein the external power source comprises a light source and the coupling device comprises a photovoltaic cell.

4. The device of claim 1 wherein the external power source comprises a heat source and the coupling device comprises a thermoelectric power generator.

5. The electrical energy storage device of claim 1 wherein the rechargeable element comprises a standard size rechargeable battery.

6. The electrical energy storage device of claim 1 wherein the device has a size substantially the same as a standard size rechargeable battery.

7. The electrical energy storage device of claim 2 wherein the coil is inductively coupled to the source of electrical power through a primary coil.

8. The electrical energy storage device of claim 1 wherein the control circuitry further comprises a rectifier and a current limiter.

9. A system for storage of electrical energy in a rechargeable element comprising:
(a) a chamber which has a primary coil coupled to a source of electrical power;
(b) a rechargeable battery including a secondary coil and control circuitry integrated with the rechargeable element, the secondary coil inductively coupled to the primary coil, the rechargeable battery being positioned inside the chamber.

10. The system of claim 8 wherein the rechargeable battery is inside an appliance.

11. The system of claim 8 wherein the appliance is selected from the group consisting of (i) a camera, (ii) a personal digital assistant, (iii) a radio, (iv) a shaver, (v) a toothbrush, (vi) a beeper, (vii) a cell phone, (viii) a chemical sensor, and, (ix) a H₂S sensor.

12. The system of claim 8 wherein the source of electrical power comprises an alternating current source.

13. The system of claim 8 wherein the source of electrical power comprises a direct current source, the system further comprising a DC/AC converter.

14. The system of claim 12 wherein the source of electrical power is selected from the group consisting of (i) and automobile, (ii) boat, and, (iii) an aeroplane.

15. A method of storing electrical energy comprising:
(a) positioning a battery integrally comprised of (A) a rechargeable element, (B) a coupling device, and (C) control circuitry, in proximity to an external source of power, the coupling device receiving power from the external source and producing electrical power;
(c) activating the external source of power; and
(d) storing electrical energy in the rechargeable element.

16. The method of claim 14 wherein the external source of power comprises an electrical source of power.

17. The method of claim 14 wherein the external power source comprises a light source.

18. The method of claim 14 wherein the external power source comprises a heat source.

19. The method of claim 15 wherein external power source comprises a primary coil and the battery is positioned inside a chamber that includes the primary coil.

20. The method of claim 15 wherein the source of electrical power comprises an alternating current source.

21. The method of claim 15 wherein the source of electrical power comprises a direct current source, the method further comprising using a DC/AC converter.
